(19) United States
(12) Patent Application Publication
(10) Pub. No.: US 2008/0213039 A1
(43) Pub. Date: Sep. 4, 2008

(54) SPRING FASTENING MEMBER

(75) Inventors: Shun-Min Chen, Taipei (TW); Hong-Bin Xu, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: WONDERLAND NURSERYGOODS CO., LTD., Taipei, (TW)

(21) Appl. No.: 11/969,700

(22) Filed: Jan. 4, 2008

(30) Foreign Application Priority Data
Jan. 18, 2007 (CN) 200720002127.2

(51) Int. Cl. F16B 21/06

(52) U.S. Cl. 403/325

(57) ABSTRACT

A spring fastening member includes two arms that can be engaged in a tube. A first protrusion and a second protrusion are respectively disposed at two corresponding sides of the spring fastening member in a direction away from the two sides of the spring fastening member when the two arms of the spring fastening member are forced to being parallel to each other. At the two corresponding sidewalls as viewed in a radial section of the tube, a first hole and a second hole are respectively disposed there for allowing the first protrusion and the second protrusion to be inserted there through. A first distance is defined between central axes of the first protrusion and the second protrusion, a second distance is defined between central axes of the first hole and the second hole, and the first distance is not equal to the second distance.

### BACKGROUND OF THE INVENTION

1. Field of the Invention

The present invention is related to a spring fastening member for assembling/disassembling a tube with other members quickly.

2. The Prior Arts

In consideration of the ease for assembly and disassembly, several products (such as, for example, baby cribs, baby chairs, etc), which are being put together from a plurality of tube structures, the assembly and disassembly between tube and tube, or between tube and other members, are mostly accomplished by means of using the spring fastening member.

The aforementioned spring fastening member includes a V-shaped spring having two arms and a tube. There are two types of configurations. FIG. 7 illustrates a first type of conventional spring fastening member, in which a post A2 is disposed on the exterior portion of an arm A1 of the V-shaped spring A; one sidewall of the aforementioned tube B is disposed with a hole B1 to permit the post A2 to protrude out while the spring A is inserted into the tube B. As the tube B, which is assembled with a spring A, is inserted inside the interior of another tube or a hole of another member, the post A2 is thereby engaged with a through hole at said another tube or another member for attaching the tube B. When required for disassembly, the post A2 is depressed to make the post A2 retreat into the tube B, and thereby separating the tube B from the another tube or members. U.S. Pat. Nos. 4,903,980 and 6,213,672 B1 are of the aforementioned designs.

FIG. 8 illustrates a second type of conventional spring fastening member, in which two posts A2 are disposed oppositely at respective arms A1, and the posts A2 are protruded at a direction away from each other. As the two arms A1 are pressed to become parallel to each other, the central axes of the two posts A2 are overlapped. The two corresponding sidewalls, as viewed in a radial section of the aforementioned tube B, each are disposed with a hole B1, respectively, for allowing the two posts A2 to be protruded out while the spring A is disposed into the tube B. U.S. Pat. Nos. 4,793,646, 5,341,829, and 6,027,409 belong to this type of design.

The spring, as illustrated in FIG. 7, therefore, is easy to slide inside the tube B or to produce a skewed phenomenon because of having a post A2 disposed at only one arm A1 as the post A2 is pressed and retracted back inside the through hole of the tube B, which makes the post A2 unable to return to the through hole.

FIG. 8 illustrates the pressing of the two arms A1 of the spring for becoming parallel to each other, in which the central axes of their two posts A2 are becoming stacked because the two posts A2 are disposed at symmetrical positions; therefore, a user can easily press down the posts A2 at the two sides. When the two posts A2 are retracted back into the through holes of the tube B, the spring can slide into the tube B or becoming skewed.

### SUMMARY OF THE INVENTION

The object of the present invention is to provided a spring fastening member that has a pair of arms respective having a first and a second protrusions which are arranged asymmetrically. When the two arms of the spring fasting member are pressed to being parallel to each other, a first distance D exists between the central axes of the first and the second protrusions. Furthermore, at asymmetrical locations respectively at the two opposite sidewalls as viewed in a radial section of a hanger tube, a first hole and a second hole are disposed for allowing the first protrusion and the second protrusion to be passed through. A second distance d exists between the central axes of the first hole and the second hole; and the first distance D may not equal to the second distance d. The aforementioned spring fastening member is to be mounted into the hanger tube, and the first protrusion and the second protrusion are respectively protruded out of the first hole and the second hole of the hanger tube.

The present invention is to provide a protrusion at each arm of the spring fastening member; therefore, as the protrusion is pressed and retracted into the through hole of the hanger tube, it can maintain positioning via the other protrusion, and would not make the entire spring fastening member to slide inside the hanger tube or to result in the skewing phenomenon. Furthermore, the spring fastening member for the present invention can therefore prevent the user from simultaneously pressing the protrusions at the two sides to cause the two protrusions to be simultaneously retracting inside the hanger tube and thereby making the entire spring fastening member to slide inside the hanger tube or become skewed by means of having the two protrusions disposed at asymmetrical positions.

### BRIEF DESCRIPTION OF THE DRAWINGS

The present invention will be apparent to those skilled in the art by reading the following detailed description of embodiments thereof, with reference to the attached drawings, in which:

FIG. 1 is a plane view illustrating a spring fastening member structure according to a preferred embodiment of the present invention;

FIG. 2 is a plane view illustrating that the two arms of the spring are pressed to be parallel to each other according to the preferred embodiment;

FIG. 3 is a plane view illustrating the hanger tube structure according to the present invention;

FIG. 4 is a perspective exploded view illustrating the preferred embodiment of the spring fastening member which is mounted on an infant swing;

FIG. 5 is a perspective view of the spring fastening member assembled inside the hanger tube according to the present invention;

FIG. 6 is a cross-sectional view illustrating the spring fastening member assembled inside the hanger tube according to the present invention;

FIG. 7 is a plane view illustrating a conventional spring fastening member structure having a single-sided protrusion; and

FIG. 8 is a plane view illustrating a conventional spring fastening member structure having a plurality of dual-sided protrusions.

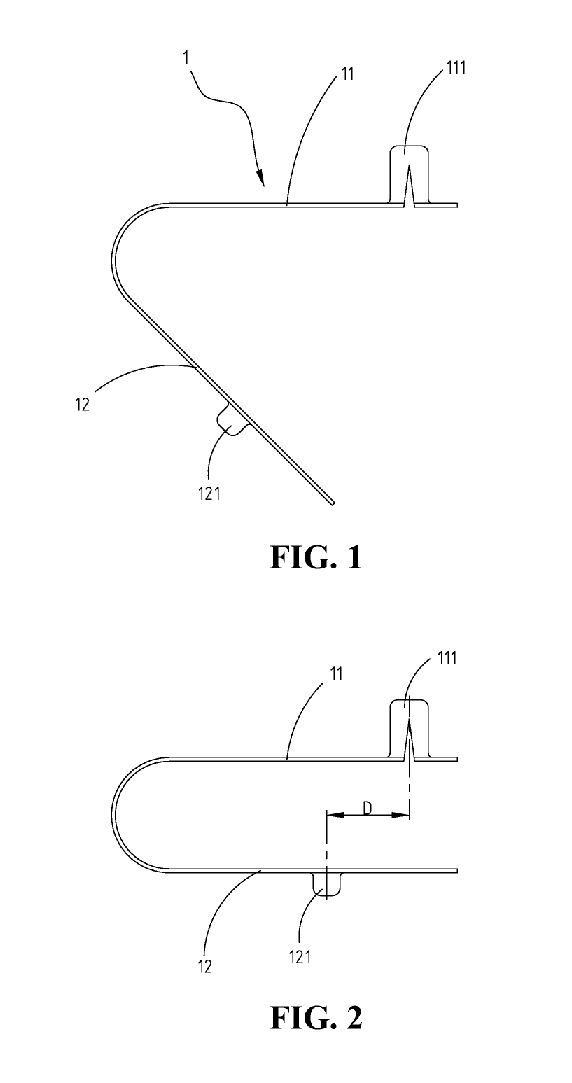

### DETAILED DESCRIPTION OF THE EMBODIMENTS

The spring fastening member 1, according to the present invention is in the form of V-shaped, in which the two portions of the V-shaped spring fastening member 1 are respectively defined as the first arm 11 and the second arm 12; a first protrusion 111 and a second protrusion 121 are formed on the first arm 11 and the second arm 12, respectively, and the first and second protrusions 111, 121 are disposed mutually apart on the aforementioned first arm 11 and the second arm 12, respectively. As the first and second arms 11, 12 are forced to be substantially parallel to each other by an external force, the central axes of the first protrusion 111 and the second protrusion 121 are in parallel. And a first distance D exists between the two central axes (as shown in FIG. 2). The first and second protrusions 111, 121 are formed on the first and second arms 11, 12 integrally, or separately which means that, the protrusion and the arm may be assembled by an interference fit. The aforementioned “interference fit” is performed where the arm having a hole that has a smaller diameter than the outside diameter of the protrusion, and the protrusion is pressed through the hole until the protrusion and the arm are firmly fastened.

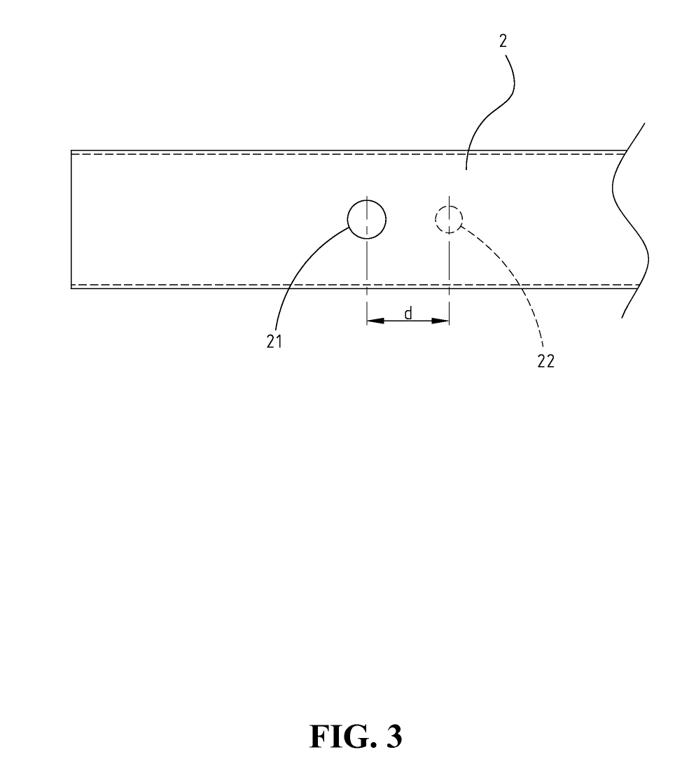

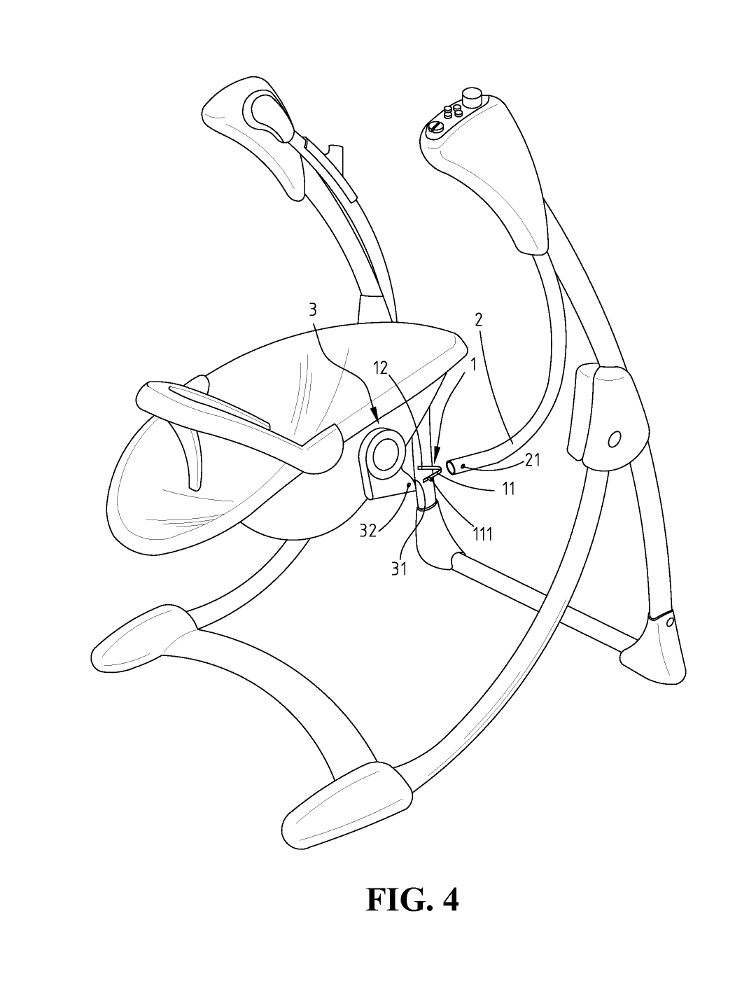

The hanger tube 2, as shown in FIG. 3, illustrates a first hole 21 and a second hole 22 for allowing the first protrusion 111 and the second protrusion 121 respectively to be passed through in the two corresponding sidewalls as viewed in the radial section. The second distance d is formed between the central axes of the first hole 21 and the second hole 22. The aforementioned first distance D is not equal to the second distance d, and the preferred embodiment is to have the first distance D longer than the second distance d.

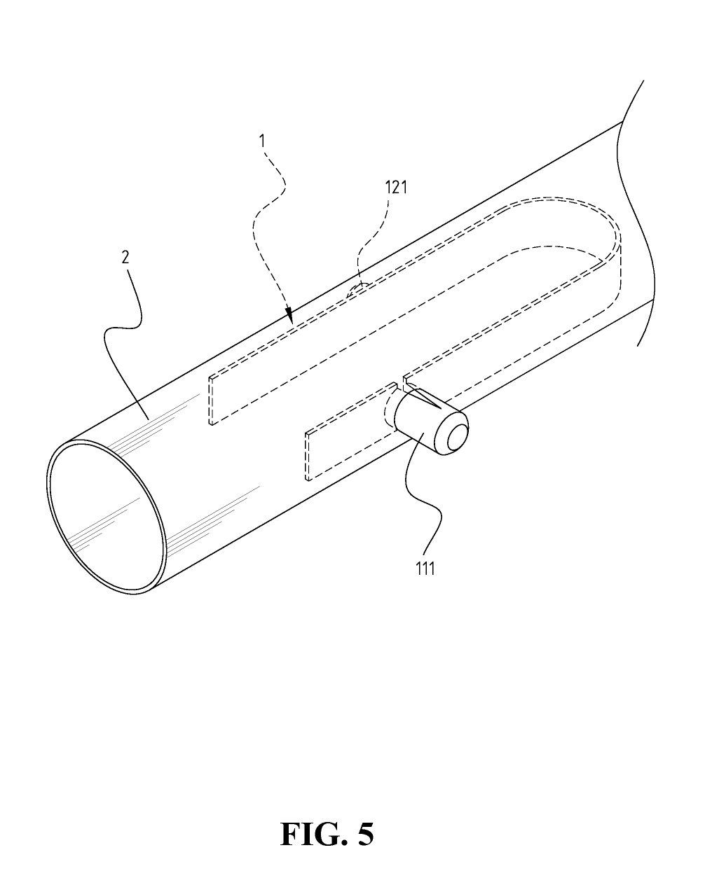

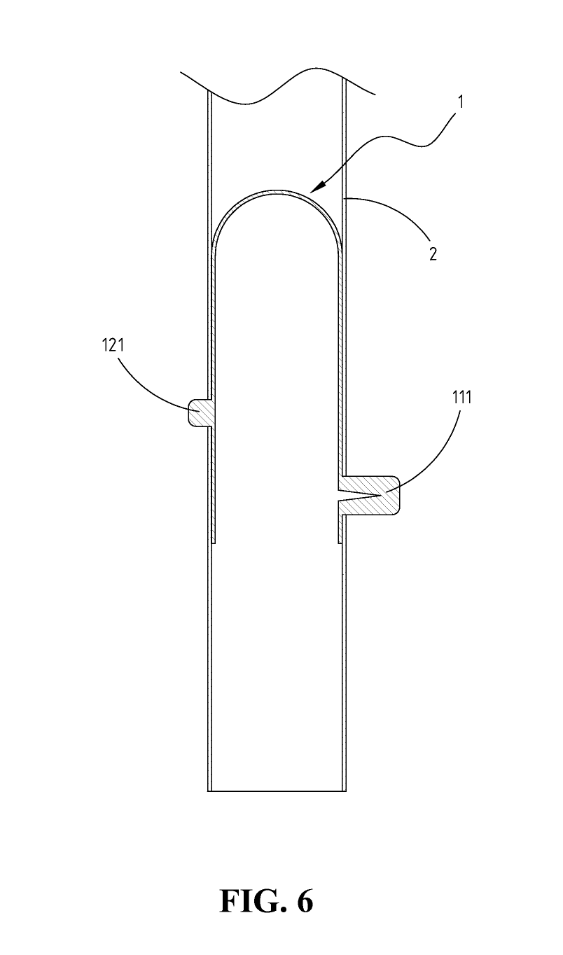

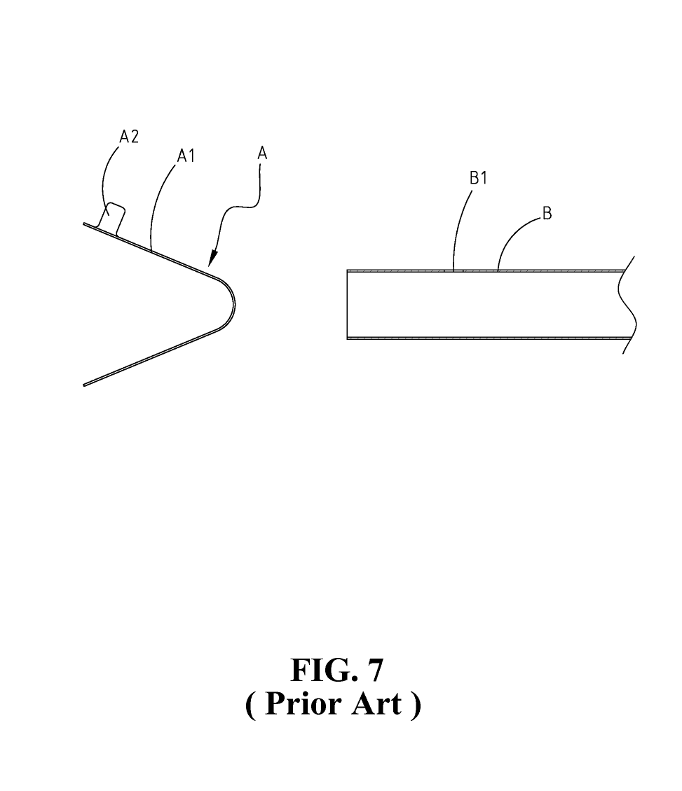

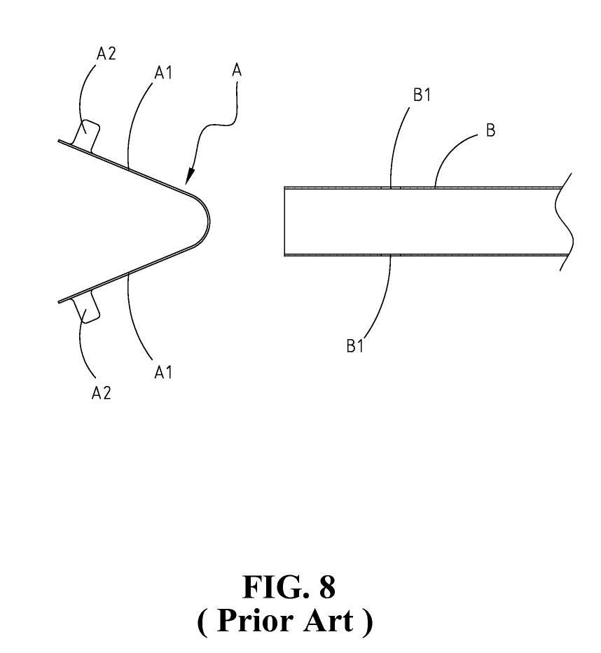

The aforementioned spring fastening member 1 is directly disposed in the inside of the hanger tube 2, upon the first arm 11 and the second arm 12 are pressed into almost parallel or the free end of the first arm 11 and the second arm 12 are approached to each other; and the spring force of the first arm 11 and the second arm 12 is used for allowing the first protrusion 111 and the second protrusion 121 to respectively pass through the first hole 21 and the second hole 22 of the hanger tube 2 ( as illustrated in FIGS. 5 and 6). The first and second protrusions 111, 121 are arranged asymmetrical at opposite ends about the center point of the spring fastening member so that the spring fastening member is retained in its original position when one of the protrusions is pressed to retract into the through hole of the hanger tube. And the entire spring fastening member not only would not be sliding inside the hanger tube or have created the skewing phenomenon, but the user can even prevent from simultaneously pressing the protrusions at the two sides to cause the two protrusions to be simultaneously retracted inside the hanger tube, thereby making the entire spring fastening member to slide inside the hanger tube.

FIG. 4 illustrates the implementation of the preferred embodiment of the present invention in an infant swing, which includes a pair of hanger tubes 2, and the two seat mounts 3 used for connecting the two hanger tubes 2 and a seat 4, the spring fastening member 1, which are formed with the first protrusion 111 and the second protrusion 121, are disposed inside the hanger tube 2, and the two protrusions are both protruded out of the hanger tube 2. The seat mount 3 includes an engagement opening 31 for allowing the insertion of the hanger tube 2. The sidewalls of the seat mount 3, as viewed in the radial section of the engagement opening 31, each have a through hole 32 corresponding to the first protrusion 111 for allowing the protrusion of the first protrusion 111. Thus, after the hanger tube 2 is inserted into the engagement opening 31, the engagement of the through hole and the protrusion of the first protrusion 111 makes the hanger tube 2 and the seat mount 3 securely engaged. When needing to separate the hanger tube 2 and the seat mount 3, the user is only required to use his fingers to depress on the first and second protrusions 111, 121 for allowing the first and second protrusions 111, 121 to retract into the through hole 32, thus allowing the withdrawing of the hanger tube 2 through the engagement opening 31.

Furthermore, regarding the spring fastening member 1 of the embodiment, the first protrusion 111 and the second protrusion 121 are cylindrical posts. The first protrusion 111 is larger than the second protrusion 121, especially when implemented in the infant swing as shown in FIG. 4, to allow the first protrusion 111 to be able to extend pass the outer edge of the seat mount for the convenient removal or disassembly operation of the hanger tube 2 by the user.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A spring fastening member assembly, comprising:
a spring fastening member including a first protrusion and a second protrusion disposed on two ends of the spring fastening member, respectively; and
a tube where the spring fastening member is disposed within, the tube includes a first hole and a second hole disposed at two corresponding sidewalls as viewed in a radial section of the tube for allowing the first protrusion and the second protrusion to pass through, wherein, as the two ends of the spring fastening member are forced to be parallel to each other, a first distance is defined between central axes of the first protrusion and the second protrusion.

2. The spring fastening member assembly as claimed in claim 1, wherein a second distance is defined between central axes of the first hole and the second hole of the tube, the first distance is not equal to the second distance.

3. The spring fastening member assembly as claimed in claim 1, wherein a second distance is defined between central axes of the first hole and the second hole of the tube, the first distance is larger than the second distance.

4. The spring fastening member assembly as claimed in claims 1, wherein the spring fastening member is V-shaped and has a pair of arms, the first protrusion and the second protrusion are projected from the arms respectively and are arranged asymmetrically.

5. The spring fastening member assembly as claimed in claims 4, wherein the central axes of the first protrusion and the second protrusion are perpendicularly projected from the arms, respectively.

6. The spring fastening member assembly as claimed in claims 1, wherein the first protrusion and the second protrusion are cylindrical posts, and the first protrusion is longer than the second protrusion.

7. The spring fastening member assembly as claimed in claims 1, wherein the first protrusion and the second protrusion are cylindrical posts, and the cylindrical diameter of the first protrusion is larger than the cylindrical diameter of the second protrusion.

8. A spring fastening member for using in an infant swing, the infant swing comprising a pair of hanger tubes and a seat having two seat mounts coupled with the two hanger tubes, respectively, the seat mounts each having an engagement opening and two through holes respectively disposed at two opposite sidewalls of the seat mount, as viewed in a radial section of the engagement opening, the hanger tubes each having a first hole and a second hole disposed at two corresponding sidewalls as viewed in a radial section of the hanger tube, wherein the spring fastening member comprises a first protrusion and a second protrusion disposed asymmetrically on two ends of the spring fastening member, respectively; and a first distance is defined between central axes of the first protrusion and the second protrusion when the two ends of the spring fastening member are forced to be parallel to each other, wherein the two seat mounts are coupled to the corresponding hanger tubes individually, the spring fastening member is inserted into the hanger tube and both the first protrusion and the second protrusion of the spring fastening member are inserted through the first hole and the second hole of the hanger tube, respectively, and both the first protrusion and the second protrusion are further coupled to the through holes of the seat mount.

9. The spring fastening member as claimed in claim 8, wherein a second distance is defined between central axes of the first hole and the second hole of the hanger tube, the first distance is not equal to the second distance.

10. The spring fastening member as claimed in claim 8, wherein a second distance is defined between central axes of the first hole and the second hole of the hanger tube, the first distance is larger than the second distance.

11. The spring fastening member as claimed in claims 8, wherein the first protrusion and the second protrusion are cylindrical posts, the first protrusion is longer than the second protrusion.

12. The spring fastening member as claimed in claims 8, wherein the first protrusion and the second protrusion are cylindrical posts, and the cylindrical diameter of the first protrusion is larger than the cylindrical diameter of the second protrusion.

13. A spring fastening member, comprising:
a first arm and a second arm connected with each other to form a V-shape; and
a first protrusion and a second protrusion are mounted on the first arm and the second arm, respectively, the first protrusion and the second protrusion are projected away from each other and are arranged on the first arm and the second arm asymmetrically.

14. The spring fastening member as claimed in claim 13, wherein the first arm and the second arm each have a connection portion connected to each other and a free end, the first protrusion is mounted near the free end of the first arm, and the second protrusion is mounted between the free end and the connection portion on the second arm.

15. The spring fastening member as claimed in claim 13, wherein the first protrusion and the second protrusion are cylindrical posts, the first protrusion is longer than the second protrusion.
